(19) United States
(12) Patent Application Publication
(10) Pub. No.: US 2012/0185677 A1
(43) Pub. Date: Jul. 19, 2012

(54) METHODS AND SYSTEMS FOR STORAGE OF BINARY INFORMATION THAT IS USABLE IN A MIXED COMPUTING ENVIRONMENT

(75) Inventors: Harry J. Beatty, III, Clinton Corners, NY (US); Peter C. Elmendorf, Poughkeepsie, NY (US); Charles Gates, Poughkeepsie, NY (US); Luo Chen, Poughkeepsie, NY (US)

(73) Assignee: INTERNATIONAL BUSINESS MACHINES CORPORATION, Armonk, NY (US)

(21) Appl. No.: 13/006,579

(22) Filed: Jan. 14, 2011

(51) Int. Cl. G06F 9/44

(52) U.S. Cl. 712/220; 712/E09.021

(57) ABSTRACT

A method of managing binary data across a mixed computing environment is provided. The method includes performing on one or more processors: receiving binary data; receiving binary coded data indicating a type of the binary data; formatting the binary data and the binary coded data according to a first format; and generating at least one of a message and a file based on the formatted data.

### BACKGROUND

The present invention relates to systems, methods, and computer program products for transferring and storing data in a binary format that may be used in a mixed computing environment.

Parallel programming is a form of parallelization of computer code across multiple processors in parallel computing environments. Task parallelism distributes execution processes (threads) across parallel computing nodes. Typically, the computing nodes are of the same computing architecture. In order to process threads across mixed computing architectures, that data should be interpretable by each of the computing architectures.

### SUMMARY

According to one embodiment, a method of managing binary data across a mixed computing environment is provided. The method includes performing on one or more processors: receiving binary data; receiving binary coded data indicating a type of the binary data; formatting the binary data and the binary coded data according to a first format; and generating at least one of a message and a file based on the formatted data.

According to another embodiment, a computer program product for storing binary data across a mixed computing environment. The computer program product includes a tangible storage medium readable by a processing circuit and storing instructions for execution by the processing circuit for performing a method. The method includes: receiving binary data; receiving binary coded data indicating a type of the binary data; formatting the binary data and the binary coded data according to a first format; and generating at least one of a message and a file based on the formatted data.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating a computing system that includes a binary data management system in accordance with exemplary embodiments;

FIGS. 2 and 3 are block diagrams illustrating the computing system of FIG. 1 in more detail in accordance with exemplary embodiments;

FIG. 4 is a dataflow diagram illustrating a binary data management system in accordance with exemplary embodiments;

FIG. 5 is an illustration of a message of the binary data management system in accordance with exemplary embodiments;

FIG. 6 is an illustration of a file of the binary data management system in accordance with exemplary embodiments; and

FIGS. 7 and 8 are flowcharts illustrating binary data management methods that may be performed by the binary data management system in accordance with exemplary embodiments.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As used herein, a binary coded type (BCT) refers to a string of bytes that represent a signature of elements of a computer program. Such elements can include, but are not limited to, data types, their attributes and their order in data structures, data objects, and function arguments and results. The BCTs can be generated, for example, by a compiler at compile time. For example, the BCTs can be static compile time constants.

In various embodiments, the BCTs are generated based on a unique naming convention using unique integers. For example, base types that are supported by the computer hardware, such as double precision or single precision floating point numbers, integers, bytes, or pointers are identified and assigned a single byte. Within that byte there can be a reserved bit that identifies whether the value represented by the type can be modified or is a constant. For example, a constant double precision floating point type is represented by 0x05, and one that can be modified is represented by 0x45.

Similar reasoning applies to the other base types. For aggregate types there are more attributes that can be set such as the structure or array can be modified, access to the aggregate should be serialized, or for memory management purposes the reference count manipulation should be serialized. These attributes vary depending on the language, but in any case these attributes are recognized as additional bits on the type byte. Negative values can similarly be used to represent universally predefined structure layouts.

An example BCT is as follows:

| Static unsigned char dcm_3BCT_7[ ] = { | |
|---|---|
| 0x80, 0x00 | /* Escape, BCT Length Op */ |
| 0x00, 0x00, 0x00, 0x05 | /*Length of following BCT*/ |
| 0x02, 0x02, 0x02, | /* Three Strings 8*/ |
| 0x04, 0x04 | /* Two Voids*/ |
| }; | |

The BCT includes an escape code, a length, and a data section. The escape code is used in BCTs for linking since the BCTs are standalone items. Note that the escape code consists of two bytes: 0x80 to indicate an escape op, and the following byte to indicate what kind of escape op. 0x00 indicates a BCT length indicator. The next bytes (e.g., four bytes) contain the length (in bytes) of the BCT data that follows. In various embodiments, this length is in memory-image order. For example, the bytes can be memcpy'd to a work area and then fetched as an integer.

Consider the example with a BCT length indicator of 5, on an IBM PowerPC machine and an Intel x86 machine. This BCT is for the RESULT of EXAMPLE_TYPE, which contains three STRINGs and two VOIDs. Strings are pointers to a null terminated character array; and a VOID is an address to an area with no defined type. In this example, the integer length field is in memory image order. All BCT fields that are not single bytes are presented in memory image order for the machine on which they are compiled. These fields are unaligned, and typically have to be copied (as bytes) to an aligned variable in order to be properly accessed. In various embodiments, to attain maximum compaction, the data in the BCT is misaligned. In various embodiments, the individual field description code and the escape code 0x8000 are not byte-swapped in the x86 example, because these codes are defined as single bytes. (The escape operator 0x80 takes the next byte as a separate subcode: it is two byte values, not a single short int value.)

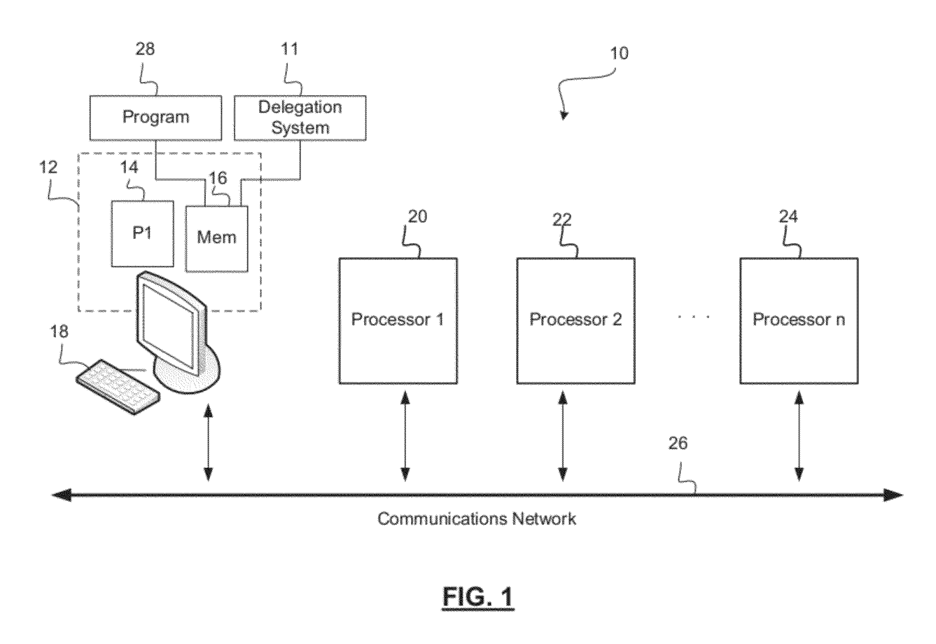

With reference now to the Figures where various exemplary embodiments will be described without limiting the same, in FIG. 1 a computer system is shown generally at 10 that includes a binary data management system 11 in accordance with various embodiments. The computer system 10 includes a first machine 12 that includes a first processor 14 that communicates with computer components such as memory devices 16 and peripheral devices 18. The computer system 10 further includes one or more other processors 20-24 that can similarly communicate with computer components 16, 18, or other components (not shown) and with the other processors 14, 20-24. In various embodiments, the one or more other processors 20-24 can be physically located in the same machine 12 as the first processor 14 or can be located in one or more other machines (not shown).

Each of the processors 14, 20-24 communicates over a network 26. The network 26 can be a single network or multiple networks and can be internal, external, or a combination of internal and external to the machine 12, depending on the location of the processors 14, 20-24.

In various embodiments, each processor 14, 20-24 can include of one or more central processors (not shown). Each of these central processors can include one or more sub-processors. The configuration of these central processors can vary. Some may be a collection of stand alone processors attached to memory and other devices. Other configurations may include one or more processors that control the activities of many other processors. Some processors may communicate through dedicated networks or memory where the controlling processor(s) gather the necessary information from disk and other more global networks to feed the smaller internal processors.

In the examples provided hereinafter, the computing machines 12 and processors 14, 20-24 will commonly be referred to as nodes. The nodes store and transfer data in a common binary format based on a binary data management methods and systems of the present disclosure.

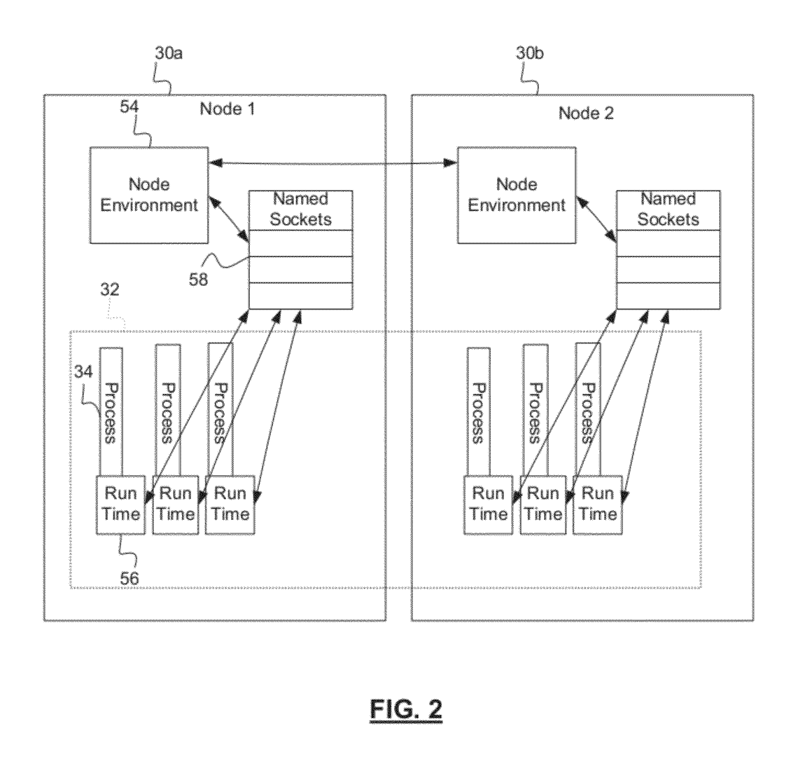

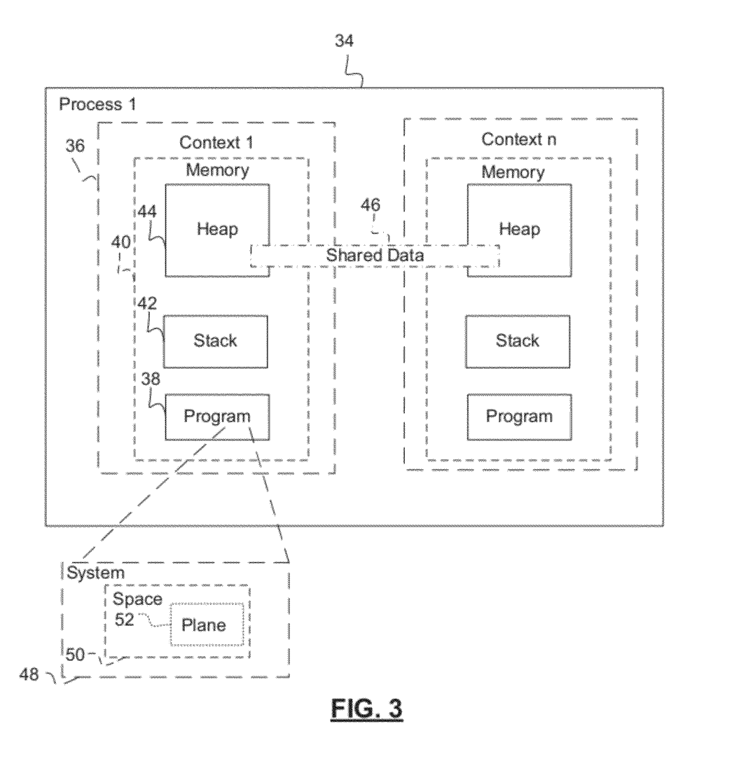

With reference now to FIGS. 2 and 3, the exemplary embodiments discussed hereinafter will be discussed in the context of two nodes 30a and 30b. As can be appreciated, the binary data management system 11 of the present disclosure is applicable to any number nodes and is not limited to the present examples. As discussed above, the nodes 30a and 30b are implemented according to different architectures. The nodes perform portions of the computer program 28 (FIG. 1). A single instantiation of a computer program 28 is referred to as a universe 32. The universe 32 is made up of processes 34.

As shown in FIG. 3, each process 34 operates as a hierarchy of nested contexts 36. Each context 36 is program logic 38 of the computer program 28 (FIG. 1) (or universe 32 (FIG. 2)) that operates on a separate memory image. Each context 36 can be associated with private memory 40, a stack 42, and a heap 44. The context 36 may have shared data 46 for global variables and certain program logic 38.

The program logic 38 of each context 36 can be composed of systems 48, spaces 50, and planes 52. For example, the universe 32 (FIG. 2) is the root of the hierarchy and within the universe 32 (FIG. 2) there can be one or more systems 48. The system 48 can be a process 34 that includes one or more spaces 50 and/or planes 52. A space 50 is a separate and distinct stream of executable instructions. A space 50 can include one or more planes 52. Each plane 52 within a space 50 uses the same executable instruction stream, each in a separate thread. For ease of the discussion, the program logic of each context 36 is commonly referred to as a module regardless of the system, space, and plane relationship.

With reference back to FIG. 2, to enable the execution of the universe 32 across the nodes 30a, 30b, each node 30a, 30b includes a node environment 54. The node environment 54 handles the operational communications being passed between the nodes 30a, 30b. In various embodiments, the node environment 54 communicates with other node environments using for example, network sockets (not shown).

To further enable the execution of the universe 32 across the nodes 30a, 30b, and within the nodes 30a, 30b, each process 34 may include or be associated with a collection of support routines called a run-time environment 56. The run-time environment 56 handles the operational communications between the processes and between the run-time environment 56 and the node environment 54. In various embodiments, the node environment 54 communicates with the node environment 54 using named sockets 58. As can be appreciated, other forms of communication means may be used to communicate between systems such as, for example, shared memory.

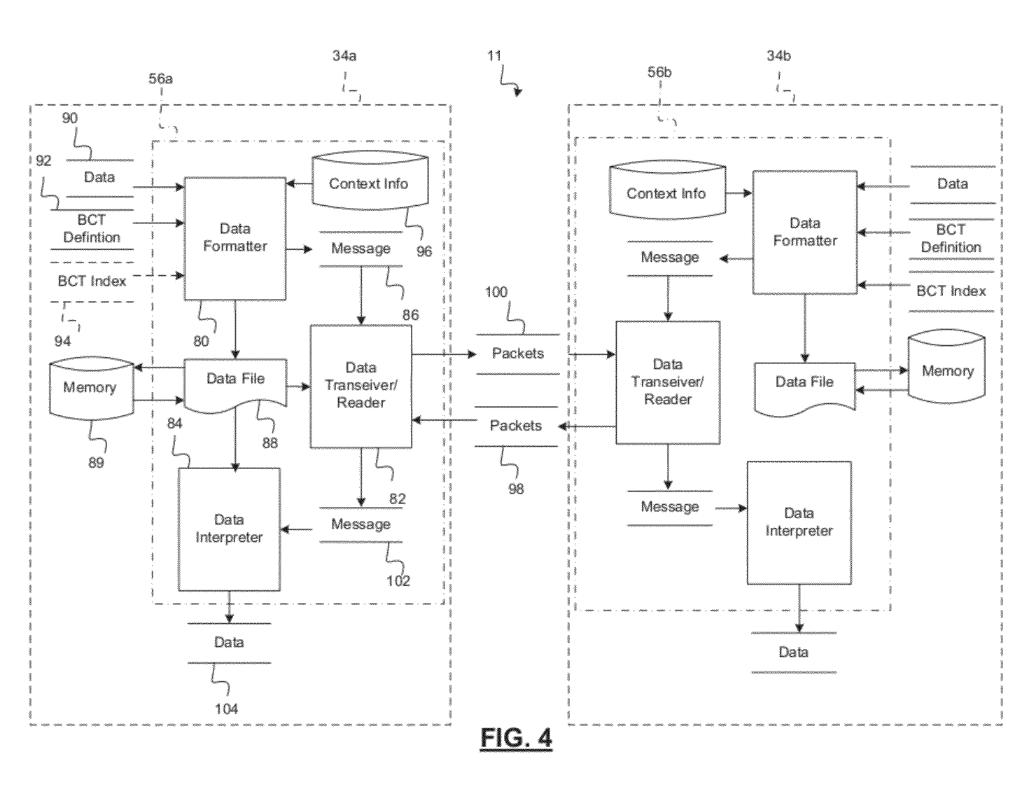

With reference now to FIGS. 4-6, portions of the run-time environment 56 and/or the node environment 54 will be described in accordance with various embodiments. In particular, the binary data management system 11 provided by the run-time environment 56 and/or the node environment 54 will be described in accordance with exemplary embodiments.

FIG. 4 illustrates the binary data management system 11 that is part of run-time environments 56a, 56b with regard to two processes 34a, 34b. As can be appreciated, the binary data management system 11 is applicable to any number of processes and is not limited to the present example. As can further be appreciated, all or portions of the binary data management system 11 may further be applicable to the node environment 54 and is not limited to the present example.

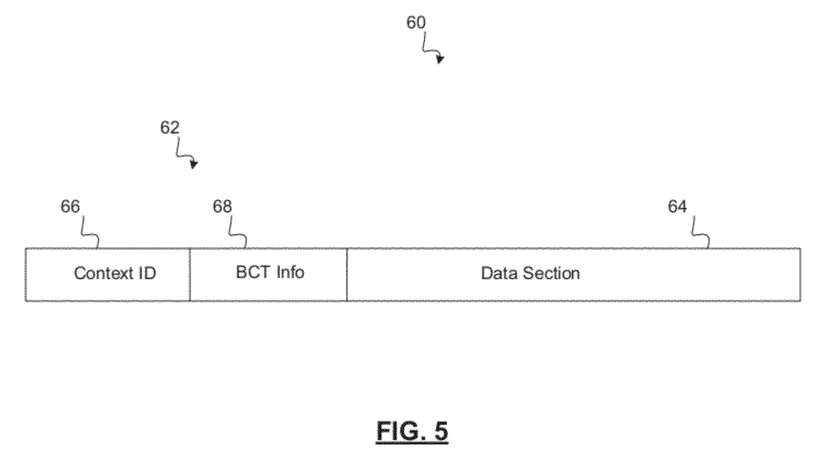

The binary data management system 11 manages the storing and transferring of data in binary form according to a predefined format. In various embodiments, as shown in FIG. 5, when the data is to be transferred (sent and received) across the network 26 (FIG. 1) as a message 60, the format of the message 60 includes an identification section 62, and a data section 64. The identification section 62 includes a sending context identification 66, a data type 68, and in some cases, an index of an associated function (not shown).

The context identification 66 includes information that indicates the architecture of the node 30a (FIG. 2) in which the data was generated. For example, the context identification 66 can be an integer number that represents the context 36. That integer number may then be used as an index to a table (not shown) of architecture definitions. The table can be maintained by the run-time environment 56 (FIG. 2) or the node environment 54 (FIG. 2). For example, the architecture definitions in the table can be predefined or populated during a linking stage of the computer program.

The data type 68 includes information that indicates the type of the data to be transferred. For example, the data type 68 can be a BCT that defines the structure or layout of the data. In another example, the data type 68 can include an index to a BCT table that stores BCT definitions for the structure and layout of the various data. The table can be maintained by the run-time environment 56 (FIG. 2) or the node environment 54 (FIG. 2). For example, the BCT definitions in the table can be predefined or populated during a linking stage of the computer program.

The data section 64 includes the data represented as single data items in binary form. That single data item may be a simple base value or a complex aggregate containing any number of nested components.

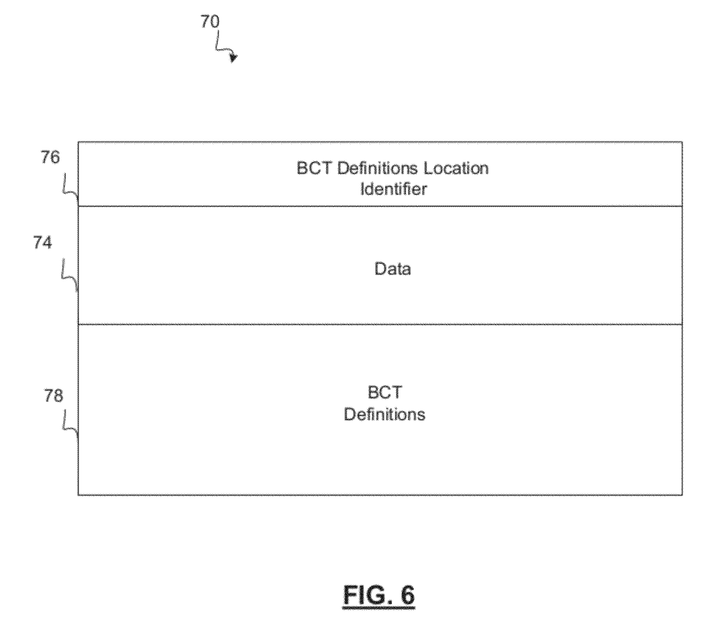

In various embodiments, as shown in FIG. 6, when the data is to be stored to a file 70, the format of the file 70 includes a BCT definition section, and a data section 74. In various embodiments, the BCT definition section includes an identifier 76 of the location of the BCT definitions and a list 78 of the BCT definitions associated with the data that is to be stored in the file 70. As can be appreciated, the location identifier 76 and the list 78 can be part of the same file 70 or can be part of different files. The data section 74 includes the data represented as single data items in binary form. The single data item may similarly be a simple base value or a complex aggregate containing any number of nested components.

With reference back to FIG. 4, in order to manage the data according to these formats, the binary data management system 11 includes at least a data formatter 80, a data transceiver reader 82, and a data interpreter 84. The data formatter 80 formats the data according to the predefined formats of FIGS. 5 and 6 and generates a message 86 and a file 88. The file 88 may be stored to memory 89.

In various embodiments, the data formatter 80 receives data 90 and an associated BCT definition 92. Alternatively, the data formatter 80 can receive the data 90 and an index 94 to the associated BCT definition that is stored in a BCT definition table. When generating the message 86, the data formatter 80 joins the context identification from a context information datastore 96 with the BCT information 92 or 94 and the data 90. The data formatter 80 then performs data alignment and packing thereon based on the typical formatting and alignment methods for that architecture.

When generating the file 88, the data formatter 80 tracks a total number of BCT definitions, and writes the total, the BCT definition, and the data to the file according to the format. The data formatter 80 writes the information using data alignment and packing methods typical for that architecture.

In various embodiments, when generating the message 86 and the file 88, the data formatter 80 can reformat the BCT definition such that any memory pointers are converted to integer offsets relative to the integer's current position. The reason for the conversion to offsets is that addresses are not shared across processes or processors, thus they carry no meaning. For example, suppose a root aggregate data structure is made up of base types such as integers, which represent their values and a pointer to another aggregate, a child. When reformatting the BCT, the data stored at the current address that the pointer is pointing to is copied to a reserved area at the end of the BCT. The pointer in the BCT is then converted to an offset. The offset indicates the distance in bytes from the offset's position to the start of the copied data.

This process can be repeated for each pointer that exists in the root aggregate, and then in all the children until all the pointers are converted. In various embodiments, the conversion can happen in either a depth first order or a breadth first order.

When the data formatter 80 formats the data, the memory allocated for each aggregate is the maximum space the aggregate would consume on the most space inefficient architecture. In this case, the aggregate consumes only the number of bytes that is required by the current architecture. The remaining space is left as padding and the contents of the pad are left as undefined.

The data transceiver/reader 82 transmits and receives the message 86 via packets 98 and 100 and reads the file 88 from memory 89. When transmitting the message 86, the data is provided in packet form. When receiving a message, the data is likewise received in packet form. The data transceiver 82 partition and assemble the messages in packet form. The data transceiver 82 ensures that the entire message is received before presenting to the message 102 for interpretation.

The data interpreter 84 processes the file 88 and processes the message 102 to determine the content. The content is then provided to the context as data 104 for use. For example, when processing the message 86, the data interpreter 84 reads in the message 102, examines the context identification, and determines the architecture of the sender. Based on the architecture, the data interpreter 84 reads the BCT definitions and the data based on one or more read methods. The read methods are based on how the data has been generated.

For example, the data is read based on whether the sending architecture was big endian or little endian. For example, in some nodes the data is read from the most significant byte to the least significant byte in two, four, or eight byte increments. Other nodes read the data from least significant byte to most significant byte in those typical increments. Therefore, if the data that is received is form an architecture with the same endian configuration, a first processing method is used that is native to the receiving architecture. If a different endian configuration is used, a second processing method that transforms the bytes in place to accommodate the difference in referencing is performed. Since the base types have the same number of bytes across the architectures this manipulation can take place “in place.”

In another example, the data is read based on the type of data alignment. For example, the data is read based on whether an eight byte data type such as a double has to start on an eight byte boundary or whether can it be aligned on a four byte boundary. Because the allocated memory is the maximum space the aggregate would consume on the most space inefficient architecture, the pad area can be used to realign the data based on the current architecture (for example when the sender's data alignment uses less memory than the receiver's architecture).

Once the data is converted to the current architecture, the data interpreter 84 interprets the data based on the BCT definitions. For example, if the BCT definition 92 data was part of the message 102 that was received, the BCT definition is simply used to read and interpret the data. Otherwise, if the BCT index 94 was part of the message 102 that was received, the BCT definition is retrieved from the BCT definitions table.

In various embodiments, when reading the data, the data interpreter 84 interprets the offsets by converting the offsets back to the pointers. For example, the data interpreter 84 can allocate memory of the size of structure and copies the data from the message into the allocated memory. Each pointer in the structure is the distance from the start of the message to the start of the data it used to point to one the sender. The receiver then allocates the structure pointed to and copies the data starting at that offset into the newly allocated memory. This can be a recursive process and it continues until all the components of the structure is fully populated. In various embodiments, the conversion can happen in either a depth first order or a breath first order, depending on what method was used by the sender/storer.

When processing the file 88, the data interpreter 84 reads in the total number of BCT definitions, reads in the BCT definitions and associates the BCT definitions with the data. Similarly, if an architecture description is provided in the file 88, based on the architecture, the data interpreter 84 reads the BCT definitions and the data based on one or more read methods. As discussed above, the read methods are based on how the data was stored.

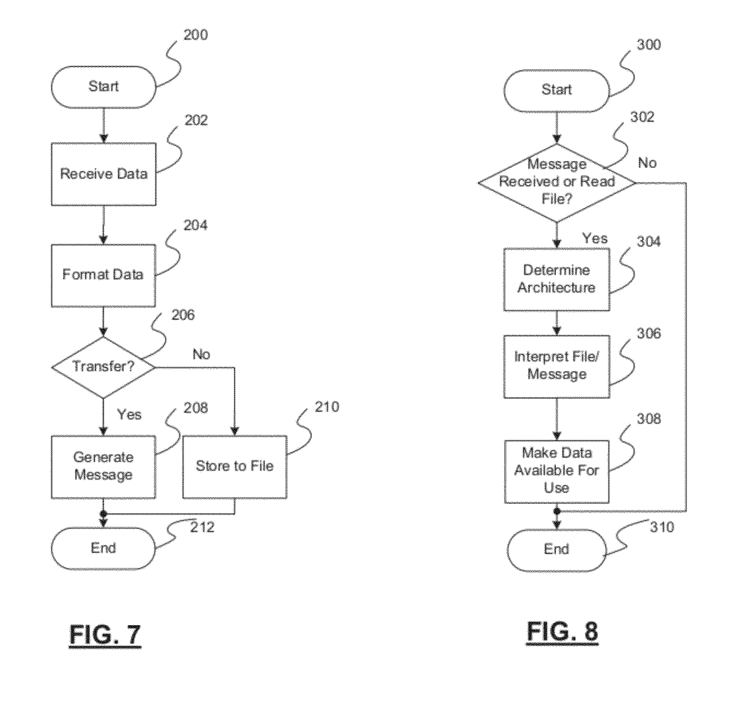

With reference now to FIGS. 7 and 8 and with continued reference to FIG. 4, flowcharts illustrate exemplary binary data management methods. As can be appreciated in light of the disclosure, the order of operation within the methods is not limited to the sequential execution as illustrated in FIGS. 7 and 8, but may be performed in one or more varying orders as applicable and in accordance with the present disclosure. As can further be appreciated, one or more steps may be added or removed without altering the spirit of the method.

In FIG. 7, the method may begin at 200. The data 90 and BCT information 92 or 94 is received at 202. The information is formatted according to, for example, one of the formats described with regard to FIGS. 5 and 6 at 204. If the information is formatted as a message 86 to be transferred at 206, the message 86 is generated in packet form at 208. If, however, the information is formatted to be stored in the file 88, the file 88 is stored at 210. Thereafter, the method may end at 212.

In FIG. 8, the method may begin at 300. It is determined whether a message 86 is received or a file 88 is read at 302. If the message 86 is received or the file 88 is read at 302, the architecture of the sender/storer is determined at 304. The content of the message 86 or the file 88 is then interpreted as discussed above at 306. The content is then made available for use by the context at 308. Thereafter, the method may end at 310.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method of managing binary data across a mixed computing environment, comprising:
performing on one or more processors:
receiving binary data;
receiving binary coded data indicating a type of the binary data;
formatting the binary data and the binary coded data according to a first format; and
generating at least one of a message and a file based on the formatted data.

2. The method of claim 1 wherein the first format includes an identification section, and a data section.

3. The method of claim 2 wherein the identification section includes a context identification and the binary coded data, and the data section includes the binary data.

4. The method of claim 1 wherein the binary coded data is an index to a table of definitions of binary coded types.

5. The method of claim 1 wherein the binary coded data is a binary coded type definition.

6. The method of claim 1 wherein the first format includes a binary coded information section and a data section.

7. The method of claim 6 wherein the binary coded information section includes a total number of binary coded type definitions and a listing of the binary coded type definitions and the data section includes the binary data.

8. The method of claim 1 wherein the formatting is based on a current architecture.

9. The method of claim 1 wherein the formatting is based on a maximum space that the data would consume across the mixed computing environment.

10. A computer program product for storing binary data across a mixed computing environment, the computer program product comprising:
a tangible storage medium readable by a processing circuit and storing instructions for execution by the processing circuit for performing a method comprising:
receiving binary data;
receiving binary coded data indicating a type of the binary data;
formatting the binary data and the binary coded data according to a first format; and
generating at least one of a message and a file based on the formatted data.

11. The computer program product of claim 10 wherein the first format includes an identification section, and a data section.

12. The computer program product of claim 11 wherein the identification section includes a context identification and the binary coded data, and the data section includes the binary data.

13. The computer program product of claim 10 wherein the binary coded data is an index to a table of definitions of binary coded types.

14. The computer program product of claim 10 wherein the binary coded data is a binary coded type definition.

15. The computer program product of claim 10 wherein the first format includes a binary coded information section and a data section.

16. The computer program product of claim 15 wherein the binary coded information section includes a total number of binary coded type definitions and a listing of the binary coded type definitions and the data section includes the binary data.

17. The computer program product of claim 10 wherein the formatting is based on a current architecture.

18. The computer program product of claim 10 wherein the formatting is based on a maximum space that the data would consume across the mixed computing environment.
